(19) United States
(12) Patent Application Publication
(10) Pub. No.: US 2026/0274515 A1
(43) Pub. Date: Sep. 17, 2026

(54) Diamond Applicator Tray

(71) Applicant: Yiwu Qingnan E-Commerce Co., Ltd., Jinhua City (CN)

(72) Inventor: Qiang Ma, Hangzhou City (CN)

(21) Appl. No.: 19/201,021

(22) Filed: May 7, 2025

(30) Foreign Application Priority Data
Mar. 13, 2025 (CN) 202520444065.9

(51) Int. Cl. B65D 25/10; B65D 1/34

(52) U.S. Cl. CPC B65D 25/107; B65D 1/34

(57) ABSTRACT

The present disclosure relates to a novel diamond applicator tray provided with a plurality of bumps distributed in a rectangular array. An accommodation space for accommodating diamonds is formed among four bumps adjacent to one another in a peripheral direction. According to the novel diamond applicator tray provided by the present disclosure, the positions of diamonds are limited by the lumps. A plurality of rows of diamonds are fixed by the bumps distributed in a rectangular array. When in use, the size of the fixed diamonds on the diamond applicator tray and the size of embellished diamonds on the painting are designed to be in a one-to-one ratio. A large number of diamonds can be directly stuck with a diamond applicator pan of a square structure, and the plurality of rows of diamond are directly transferred and stuck on the painting in a large area.

### CROSS REFERENCE TO RELATED APPLICATION

This application claims the benefit of and takes priority from Chinese Patent Application No. 202520444065.9 filed on Mar. 13, 2025, the contents of which are herein incorporated by reference.

### TECHNICAL FIELD

The present disclosure belongs to the technical field of diamond painting tools, in particular to a novel diamond applicator tray.

### BACKGROUND

In view of the facts that diamond paintings in the market are getting bigger and bigger and large-area paintings need more diamonds, the larger the painting, the higher the workload is. If a single diamond applicator pen or a single row of diamond applicator pens is used, the workload becomes very large. Therefore, a novel diamond applicator pen is of a square structure composed of multiple horizontal rows and vertical rows of diamond applicator pens, which can paste diamonds in a larger area at the same time. However, the traditional diamond applicator tray is designed in a strip shape regardless of the shape, and only plays a role in arranging the diamonds. A single diamond or a single row of diamonds is pasted by the diamond applicator pen.

### SUMMARY

For this purpose, an object of the present disclosure is to provide a novel diamond applicator tray in view of disadvantages in the prior art, so that the workload of diamond application can be reduced, and the work efficiency is improved.

In order to achieve the above-mentioned purpose, the present disclosure adopts the following technical scheme.

A novel diamond applicator tray includes a tray. The tray is provided with a plurality of bumps distributed in a rectangular array. An accommodation space for accommodating diamonds is formed among four bumps adjacent to one another in a peripheral direction.

In order to realize the present disclosure preferably, further optimization is made in the above structure. The bump is of a diamond-shaped structure.

In order to realize the present disclosure preferably, further optimization is made in the above structure. The tray is made of plastics.

In order to realize the present disclosure preferably, further optimization is made in the above structure. The novel diamond applicator tray further includes a tray cover. The tray is covered with the tray cover, and a discharge hole is formed in the tray or the tray cover.

In order to realize the present disclosure preferably, further optimization is made in the above structure. The tray is covered with the tray cover vertically downwards.

In order to realize the present disclosure preferably, further optimization is made in the above structure. The discharge hole is formed in the top of the tray cover.

In order to realize the present disclosure preferably, further optimization is made in the above structure. The tray is covered with the tray cover horizontally and slidably.

In order to realize the present disclosure preferably, further optimization is made in the above structure. The discharge hole is formed in a side surface of the tray.

In order to realize the present disclosure preferably, further optimization is made in the above structure. Sliding chutes are formed in both sides of the tray cover, and the tray is inserted between the two sliding chutes to be slidably connected with the two sliding chutes.

Compared with the prior art, the present disclosure has the following beneficial effects.

According to the novel diamond applicator tray provided by the present disclosure, traditional dividing strips are abandoned. The positions of diamonds are limited by the lumps. A plurality of rows of diamonds are fixed by the bumps distributed in a rectangular array. When in use, the size of the fixed diamonds on the diamond applicator tray and the size of embellished diamonds on the painting are designed to be in a one-to-one ratio. A large number of diamonds can be directly stuck with a diamond applicator pan of a square structure, and the plurality of rows of diamond are directly transferred and stuck on the painting in a large area, so that the workload of diamond application is reduced, the work efficiency is improved, and the completion time of painting is reduced.

### BRIEF DESCRIPTION OF THE DRAWINGS

In order to illustrate the technical scheme in the embodiment of the present disclosure or in the prior art more clearly, the attached figures needing to be used in the embodiment or in the description in the prior art are simply described. Apparently, the embodiments in the following description are merely a part rather than all of the embodiments of the present disclosure. For any person skilled in the art, under the premise of without contributing creative labor, other attached figures further can be obtained according to these attached figures.

FIG. 1 is a first structure diagram of a novel diamond applicator tray provided by the present disclosure.

FIG. 2 is a second structure diagram of a novel diamond applicator tray provided by the present disclosure.

FIG. 3 is a third structure diagram of a novel diamond applicator tray provided by the present disclosure.

### REFERENCE SIGNS

1, tray; 2, bump; 3, accommodation space; 4, discharge hole; 5, tray cover; and 6, sliding chute.

### DETAILED DESCRIPTION OF THE EMBODIMENTS

In order to make the purpose, technical scheme and advantages of the present disclosure more clear, the technical scheme of the present disclosure is described in detail as follows. Apparently, the embodiments in the following description are merely a part rather than all of the embodiments of the present disclosure. Based on the embodiment in the present disclosure, all other embodiments obtained by the ordinary technical staff in the art under the premise of without contributing creative labor belong to the scope protected by the present disclosure.

In the description of the present disclosure, it needs to be illustrated that, except as otherwise noted, the meaning of “a plurality of” is two or more than two; and the indicative direction or position relations of the terms such as “upper”, “lower”, “left”, “right”, “inside”, “outside”, “front end”, “rear end”, “head” and “tail” are direction or position relations illustrated based on the accompanying diagrams, just for facilitating the description of the present disclosure and simplifying the description, but not for indicating or hinting that the indicated device or element must be in a specific direction and is constructed and operated in the specific direction, the terms cannot be understood as the restriction of the present disclosure. Moreover, the terms such as “first”, “second”, and “third” are just used for distinguishing the description, but cannot be understood to indicate or hint relative importance.

In the description of the present disclosure, it further needs to be illustrated that, except as otherwise noted, the terms such as “mount”, “link” and “connect” should be generally understood. For example, the components can be fixedly connected, and also can be detachably connected or integrally connected; the components can be mechanically connected, and also can be electrically connected; and the components can be directly connected, and also can be indirectly connected through an intermediate. For those skilled in the art, the specific meanings of the terms in the present disclosure can be visually understood according to specific conditions.

### Embodiment I

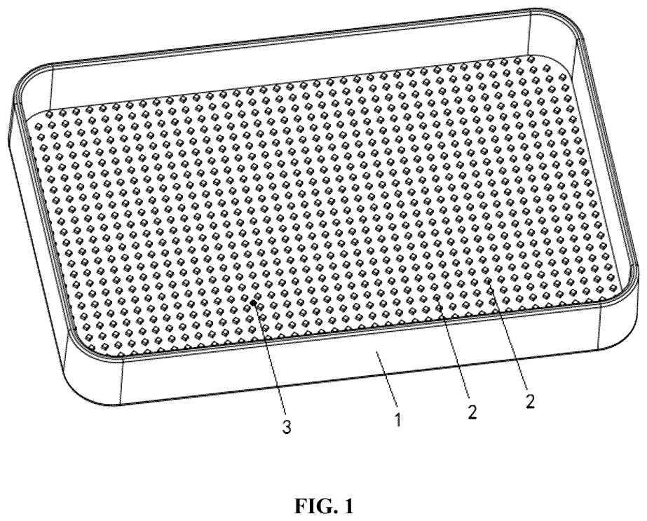

As shown in FIG. 1, in the first embodiment, a novel diamond applicator tray provided by the present disclosure includes a tray 1. The tray 1 is made of plastics, and is high in economical efficiency. The tray 1 is provided with a plurality of bumps 2 distributed in a rectangular array. An accommodation space 3 for accommodating diamonds is formed among four bumps 2 adjacent to one another in a peripheral direction. The accommodation space 3 surrounded by the bumps 2 can accommodate a plurality of rows of diamonds. During practical application, the size of fixed diamonds on the diamond applicator tray and the size of embellished diamonds on the painting are designed to be in a one-to-one ratio. A large number of diamonds can be directly stuck with a diamond applicator pan of a square structure, and the plurality of rows of diamond are directly transferred and stuck on the painting in a large area, so that the workload of diamond application is reduced, the work efficiency is improved, and the completion time of painting is reduced.

In the embodiment, the bump 2 is designed into a diamond-shaped structure, so that four side surfaces of the bump 2 can be in contact with four diamonds respectively to limit the positions of the diamonds through the four side surfaces.

Since the diamonds are fixed by limiting the bumps 2 in the present disclosure, the bumps play a blocking role when excess diamonds are taken out, and the diamonds cannot slide out of the tray like the traditional diamond applicator tray. Therefore, in order to facilitate to take out the diamonds, a tray cover 5 is provided for assistance. The tray 1 is covered with the tray cover 5, and a discharge hole 4 is formed in the tray 1 or the tray cover 5. Refer to embodiment II and embodiment III for details.

### Embodiment II

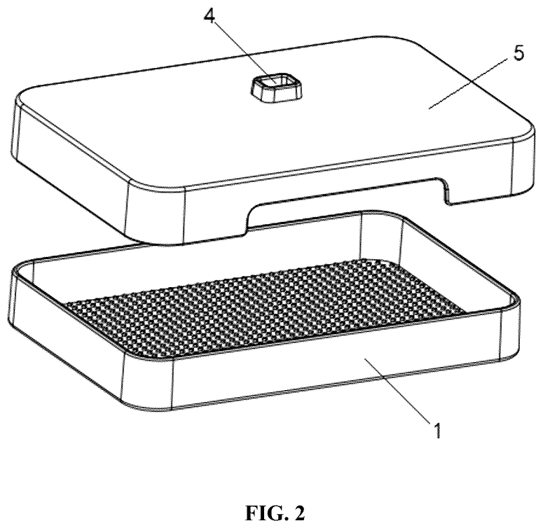

As shown in FIG. 2, in the second embodiment, a novel diamond applicator tray provided by the present disclosure includes a tray cover 5. The tray 1 is covered with the tray cover 5 vertically downwards. A discharge hole 4 is formed in the top of the tray cover 5. The tray 1 is covered with the tray cover 5 so that the diamonds are wrapped inside. The diamonds inside the tray 1 are fallen into the tray cover 5 by overturning the tray 1, and finally the diamonds are discharged out from the discharge hole 4.

### Embodiment III

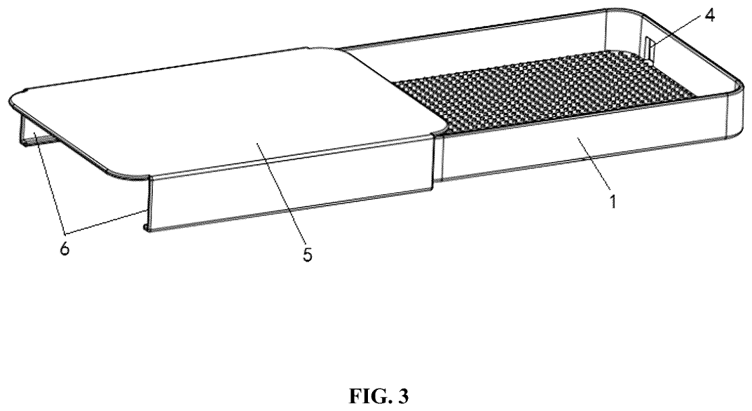

As shown in FIG. 3, in the third embodiment, according to a novel diamond applicator tray provided by the present disclosure, the difference between the embodiment and the second embodiment lies in that the tray 1 is covered with the tray cover 5 horizontally and slidably. A discharge hole 4 is formed in a side surface of the tray 1. After covering of the tray cover 5, the tray 1 is tilted so that the diamonds inside the tray are discharged out from the discharge hole 4.

In the embodiment, sliding chutes 6 are formed in both sides of the tray cover 5, and the tray 1 is inserted between the two sliding chutes 6 to be slidably connected with the two sliding chutes 6.

The foregoing descriptions are merely specific embodiments of the disclosure, but are not intended to limit the protection scope of the disclosure. Any variation or replacement readily figured out by a person skilled in the art within the technical scope disclosed in the disclosure shall fall within the protection scope of the disclosure. Therefore, the protection scope of the present disclosure shall be subject to the protection scope of the claims.

What is claimed is:

1. A novel diamond applicator tray, comprising a tray (1), wherein the tray (1) is provided with a plurality of bumps (2) distributed in a rectangular array, an accommodation space for accommodating diamonds being formed among four bumps (2) adjacent to one another in a peripheral direction.

2. The novel diamond applicator tray according to claim 1, wherein the bump (2) is of a diamond-shaped structure.

3. The novel diamond applicator tray according to claim 1, wherein the tray (1) is made of plastics.

4. The novel diamond applicator tray according to claim 1, further comprising a tray cover (5), wherein the tray (1) is covered with the tray cover (5), a discharge hole (4) being formed in the tray (1) or the tray cover (5).

5. The novel diamond applicator tray according to claim 4, wherein the tray (1) is covered with the tray cover (5) vertically downwards.

6. The novel diamond applicator tray according to claim 5, wherein the discharge hole (4) is formed in the top of the tray cover (5).

7. The novel diamond applicator tray according to claim 4, wherein the tray (1) is covered with the tray cover (5) horizontally and slidably.

8. The novel diamond applicator tray according to claim 7, wherein the discharge hole (4) is formed in a side surface of the tray (1).

9. The novel diamond applicator tray according to claim 8, wherein sliding chutes (6) are formed in both sides of the tray cover (5), the tray (1) being inserted between the two sliding chutes (6) to be slidably connected with the two sliding chutes (6).
